(19) United States
(12) Patent Application Publication
(10) Pub. No.: US 2005/0188965 A1
(43) Pub. Date: Sep. 1, 2005

(54) EGR gas cooling apparatus

(75) Inventor: Shoichiro Usui, Shizuoka (JP)

Correspondence Address: MORGAN LEWIS & BOCKIUS LLP, 1111 PENNSYLVANIA AVENUE NW, WASHINGTON, DC, 20004, US

(73) Assignee: USUI KOKUSAI SANGYO KAISHA, LTD.

(21) Appl. No.: 11/048,055

(22) Filed: Feb. 2, 2005

(30) Foreign Application Priority Data
Feb. 3, 2004 (JP) P. 2004-026541

(51) Int. Cl. F02M 25/07

(52) U.S. Cl. 123/568.12

(57) ABSTRACT

The pre-EGR gas cooler 1 for cooling the EGR gas introduced from the EGR pipe, and an post-EGR gas cooler for introducing the pre-EGR gas cooled in the EGR gas cooler 1 to cool it to a target cooling temperature are coupled in series, and an EGR valve is mounted for controlling the flow rate of the EGR gas between the pre-EGR gas cooler 1 and the post-EGR gas cooler 3. According to the invention, EGR gas cooling apparatus with improved durability can be obtained, and EGR valves with low product cost and high storage efficiency can be provided.

### BACKGROUND OF THE I MENTION

The present invention relates to an EGR gas cooling apparatus for cooling EGR gas by heat-exchanging with a cooling-medium, and more particularly, to an EGR gas cooling apparatus having improved durability, in which an EGR valve is protected in high temperatures to improve the durability of apparatus, and the EGR valve provided in the EGR gas cooling apparatus controls a flow rate of the EGR gas supplied to an intake air.

Conventionally, EGR systems, in which a part of exhaust gas is taken out of the exhaust gas system and returned to an intake system of the engine to be added to the mixture gas or the intake air with the control of the EGR valve, are used in engines for automobiles such as gasoline engines and diesel engines. This EGR system, particularly a high EGR-rate cooled EGR system for diesel engine has an EGR gas cooling apparatus that cools high temperature EGR gas by using a refrigerant liquid such as cooling water, cooling air, refrigerant for automobile air conditioner to decrease the amount of NOₓ in the exhaust gas, and to prevent the deterioration of fuel efficiency, and to prevent the deterioration of the function or durability of the EGR valve due to the excessive temperature increase.

As an EGR gas cooling apparatus, there is an EGR gas cooling apparatus in which one EGR gas cooler is installed in the apparatus, and a metallic heat conduction pipe having a small diameter, in which the EGR gas introduced through the EGR pipe from the exhaust manifold can flow through the interior thereof, or a metallic heat conduction plate is disposed in the heat exchanging part of the EGR gas cooler. And the appropriate refrigerant liquid flows in the heat exchanging part, and passes through the heat conduction portion of the heat conduction pipe or the heat conduction plate, and exchanges heat with the EGR gas, and then the EGR gas is cooled indirectly.

Further, to control the introduction and introduction-stopping of the EGR gas into the intake air, and to control the flow rate into the desired rate, as the invention shown in Patent Documents 1 to 3, an EGR valve is provided at any one of the front or rear side of the EGR gas cooler. Also, as an invention related to the EGR valve, Patent Documents 4 to 8 disclose that the one side end of a valve shaft is coupled to a valve which is deposed to freely open and close the flow path of the EGR, and a valve shaft is moved by an actuator coupled to the other end of the valve shaft, and the opening and closing of the flow path of the ERG gas is controlled with the valve. Additionally, the actuator performing the operation of the valve uses an air cylinder such as that disclosed in Patent Documents 4, 5 or 7, or an electric-magnetic valve having a solenoid built-in such as Patent Document 6, or a diaphragm such as that disclosed in Patent Document 8.

In addition, as a different conventional technology of the EGR valve, there is a two-port type EGR valve in which two circulation pipes are built and valves that can hermetically seal the valve discs of each circulation hole are built at the upper and lower part of a valve shaft at regular intervals to introduce a large amount of EGR gas to the EGR gas cooler. In this EGR valve, the valve shaft is operated up and down by activating the actuator and then a pair of valves are separated from the corresponding vale discs, and the two circulation holes open simultaneously, and finally EGR gas flows into the EGR gas cooler. In the case of valve-closing, the two circulation holes are closed simultaneously by fitting a pair of valves in the corresponding valve discs.

[Patent Document 1]

Japanese Unexamined Patent Application Publication No. Hei9-324707

[Patent Document 2]

Japanese Unexamined Patent Application Publication No. 2000-74592

[Patent Document 3]

Japanese Unexamined Patent Application Publication No. 2003-184659

[Patent Document 4]

Japanese Unexamined Patent Application Publication No. Hei11-141411

[Patent Document 5]

Japanese Unexamined Patent Application Publication No. 2000-282964

[Patent Document 6]

Japanese Unexamined Patent Application Publication No. Hei7-301155

[Patent Document 7]

Japanese Unexamined Patent Application Publication No. 2001-90617

[Patent Document 8]

Japanese Unexamined Patent Application Publication No. Hei10-159663

In the case of an EGR system using a single EGR gas cooler such as a conventional technology, since only one EGR gas cooler is used for cooling a high temperature EGR gas to the desired temperature, contacting frequency between the EGR gas and the refrigerant liquid should be increased or a low temperature refrigerant liquid is necessary. From the foregoing reasons, the EGR gas cooler becomes larger and thermal deformation happened, and also there is a possibility the temperature difference between the EGR gas and the refrigerant liquid becomes bigger. Due to the foregoing reasons, thermal stress is increased, so that increasing the durability of the EGR gas cooler is necessary.

Due to using a low temperature refrigerant liquid, the temperature of the heat conduction face becomes lower, and water vapor, unburned gas, sulfuric acid solution and hydrocarbon contained in the EGR gas are condensed and liquidized, and then easily deposited on the heat conduction faces. To prevent the metal corrosion due to the condensate, heat conduction pipes, heat conduction plates or materials for brazing is formed with the high anticorrosive material, which causes the increase of cost. Also, in the heat conduction face, the soot in the EGR gas is deposited simultaneously with the precipitation of the condensate, whereby a moisturized viscous soot layer having a high bulk density of particles is deposited on the heat conduction face, and the soot layer creates a heat insulation effect, which reduces the heat conduction effect of the heat conduction face, so that the efficiency of the heat exchange may be deteriorated.

Also, such as Patent documents 1 and 2, in the case an EGR valve is installed at the front side of the EGR gas cooler, a high temperature EGR gas is passed through the EGR valve, the high temperature EGR gas may be leaked to the actuator side along the valve shaft inserted between the actuator and the flow path of the EGR gas. Due to the high temperature EGR gas, the degradation of the actuator happens, so that the life span of the EGR valve is shortened. Also, to prevent the leakage of the EGR gas, a high-priced seal member having a high thermal resistance is necessary to e used between the actuator and the flow path of the EGR gas, which cause to increase the product cost.

In Patent Documents 4, 5 and 7, to prevent the disadvantages caused by the high temperature heat, a seal member is protected from the heat of the EGR gas by cooling the actuator by circulating the coolant on the outer circumference of a cylinder of the actuator, thereby improving the durability of the product. And also, in the Patent Document 8, the EGR valve is cooled by using the air-cooled method, in which a part of the intake air is introduced into the EGR valve. However, installing such a cooling apparatus causes the increase in the size, weight and complexity of the EGR valve so that a manufacturing cost is increased and a space to hold the valve is needed. And also, in the case of an air-cooled type one using an intake air such as Patent Document 8, to cool the EGR valve sufficiently, a lot of the intake air should be introduced by enlarging a cooling apparatus, which causes the increase in the size, weight and complexity of the EGR valve and a space to hold the valve is needed.

Also, in the case the 2-port type EGR valve having a pair of valve discs and valves is installed at the front side of the EGR gas cooler, when a valve shaft between a pair of valves or a main body with a pair of valve discs is thermally expanded due to the heat conduction from the high temperature EGR gas, the distance between a pair of valve discs and the distance between a pair of the valves are made different from the difference in the coefficient of thermal expansion due to the difference in their materials. From the foregoing reasons, when closing the EGR valve, any one or both of the valves can not be located accurately at the valve discs, so that a close property of the EGR valve is lowered.

To solve the above problem, a distance after the thermal expansion of a pair of valve discs and a pair of valve should be restrictly adjusted, so that structure and manufacturing process become complex and the cost increased.

On the contrary, as shown in Patent Documents 2 and 3, in the case installing an EGR valve at the rear side of the EGR gas cooler, namely at the position lower than the outlet hole, an EGR gas cooled by the EGR gas cooler is passed through the EGR valve, so that the deterioration of the seal element or the degradation of the air-tightness is not followed. However, a low temperature EGR gas may contain highly corrosive condensate viscous soot having a high bulk density of particles. The EGR gas containing them is leaked to the actuator, and the corrosion of parts or the deposition of soot is progressed and adhered, so that the actuator can not work smoothly. Specially, an electric-magnetic valve such as Patent Document 6, since the durability against a highly corrosive condensate or soot is low, a high-priced seal member having a good anticorrosion and a high air-tightness is necessary to prevent the degradation of the electric-magnetic valve.

### SUMMARY OF THE INVENTION

The present invention is designed to solve the above-mentioned problems, and it is an object of the present invention to improve the durability of an EGR gas cooling apparatus, specially an EGR valve, by inhibiting the precipitation of the condensate by water vapor, unburned gas, sulfuric acid solution and hydrocarbon contained in the EGR gas or the generation of a moisturized viscous soot having a high bulk density of particles, and to reduce the thermal stress due to the thermal distortion or temperature difference in the EGR gas cooler. Further, it is another object of the present invention to obtain a high quality product having a good durability by keeping the smooth operation property or the air-tightness of the EGR valve by inhibiting the degradation of various parts, by arranging the EGR valve at the location where the EGR valve is not likely to contact with a highly corrosive condensate or the viscous soot having a high bulk density, and by not exposing the EGR valve to a high temperature. Furthermore, it is still another object of the present invention to reduce the product cost and maintenance cost of the EGR valve by not using a high anticorrosive or a high thermal resistance material, and also by forming without performing the highly accurate control of parts in consideration of the thermal expansion rate. Moreover, it is yet still another object of the present invention to prevent the increase in the size and weight of the EGR valve, and in the complexity of its structure and to provide an EGR valve having good storage efficiency by disusing a cooling section of the EGR valve with the avoidance from a high temperature EGR gas

In order to achieve the above-mentioned objects, the present invention provides an EGR gas cooling apparatus including: a pre-EGR gas cooler for cooling EGR gas introduced from EGR pipe; an post-EGR gas cooler for introducing and cooling the EGR gas cooled in the pre-EGR gas cooler; and an EGR valve for connecting in series the pre-EGR gas cooler and the post-EGR gas cooler, which controls the flow rate of the EGR gas which installed between the pre-EGR gas cooler and the post-EGR gas cooler.

Further, it is preferable that the pre-EGR gas cooler indirectly cools the EGR gas by circulating a fluid having a high boiling point in a heat exchanger.

Still further, it is preferable that the pre-EGR gas cooler is coupled to a cooler for a refrigerant liquid which indirectly cools a thermal medium fluid having a high boiling point by air-cooling or liquid-cooling; a circulating-pump and/or a controlling-valve are provided in the supply path of a heating medium fluid having a high boiling point from the cooler for the refrigerant liquid; and the flow rate of the thermal medium fluid having a high boiling point of the heat exchanging part of the pre-EGR gas cooler is controlled or stopped of supplying by increasing and decreasing the flow rate of the circulation pump and/or by opening and closing the controlling-valve.

Still further, it is preferable that the pre-EGR gas cooler cools the EGR gas to a temperature of 150° C. to 200° C.

Still further, it is preferable that a boiling point of the thermal medium fluid is 150° C. or more.

### BRIEF DESCRIPTION OF THE DRAWINGS

FIG. 1 is the concept drawing indicating the EGR gas cooling apparatus according to the first embodiment of the present invention.

FIG. 2 is the concept drawing indicating the EGR gas cooling apparatus according to the second embodiment of the present invention.

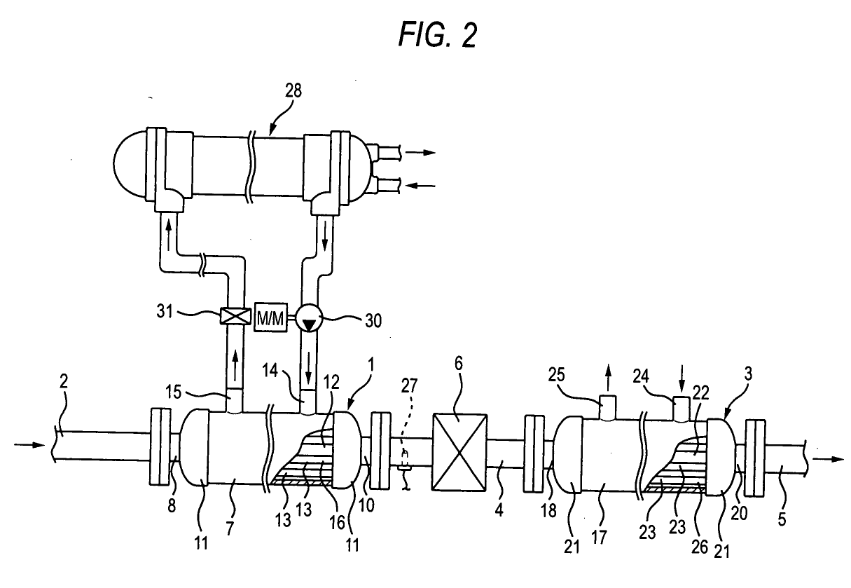

### DETAILED DESCRIPTION OF THE PREFERRED EMBODIMENTS

[Embodiment 1]

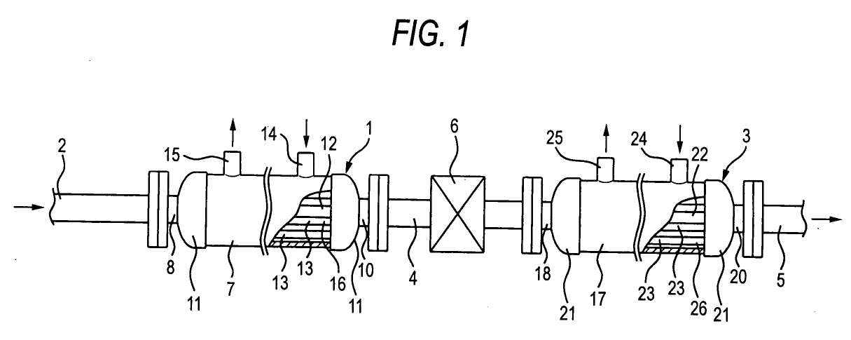

Hereinafter Embodiment 1 in which the EGR gas cooling apparatus of the present invention is used in an automobile will be described with reference to FIG. 1. A pre-EGR gas cooler 1 that performs the first step of cooling by introducing a high temperature EGR gas is coupled to the one end of the introduction pipe 2, in which a coupling hole(not shown) to the EGR pipe of the exhaust manifold side is installed. An post-EGR gas cooler 3, in which a medium temperature EGR gas cooled at the pre-EGR gas cooler 1 is introduced to cool down to the desired temperature, is coupled to the end of the pre-EGR gas cooler 1 in series through a second supplying pipe 4. The post-EGR gas cooler 3 is coupled to an outlet pipe 5 that is coupled to an intake manifold and passed therethrough at the other end, so that it is possible to supply a low temperature EGR gas, cooled to the desired temperature, to the intake manifold.

And, the EGR valve 6 is installed on the second supplying pipe 4 between the pre-EGR gas cooler 1 and the post-EGR gas cooler 3, whereby the flow rate of the EGR gas to an intake air is controlled, and also it is possible to introduce or to stop introducing as controlling the flow rate of the EGR gas to the EGR gas cooling apparatus. The EGR valve 6 is not shown, but a flow path of the EGR gas is installed therein, and a valve shaft is air-tightly inserted into the flow path of the EGR gas and the actuator, and a valve, which is installed at one end of the valve shaft, is placed at the location fit to the valve disc in the flow path of the EGR gas, and the valve is placed at or dropped from the valve disc by the operation of the actuator, whereby the opening and closing of the EGR valve 6 is controlled. Also, the actuator controlling the operation of the valve through the valve shaft may be an air cylinder such as Patent Documents 4, 5 and 7, and an electric-magnetic valve such as Patent 6, a diaphragm-used one such as Patent document 8 and other means will be fine, so that the operation means are not important.

As shown in FIG. 1, the pre-EGR gas cooler 1 is coupled to a bonnet 11 in which an introduction hole 8 and an outlet hole 10 of the EGR gas are installed at both ends of the body pipe 7 having a cylinder shape, and an introduction hole 8 is coupled to a supplying pipe 2, and an outlet hole 10 is coupled to a second supplying pipe 4. Also, a plurality of the heat conduction pipe 13, made of a heat resistance metal pipe, stainless pipe and the like, are placed on a heat exchanging part 12 installed in the body pipe 7. And a high temperature EGR gas, introduced through an introduction hole 8 from a supplying pipe 2, flows in a heat conduction pipe 13, thereafter passing through the outlet hole 10 and discharging to a second supplying pipe 4. Also, a refrigerant introducing-route 14 and a refrigerant discharging-route 15 are installed in a body pipe 7 to supply and circulate a refrigerant liquid to the heat exchanging part 12, and in the heat exchanging part 12, the outer circumference of the heat conduction pipe 13 is prepared to flow the refrigerant liquid, and it makes possible to do the heat-exchange between a high temperature EGR gas and the refrigerant liquid by passing through a metallic heat conduction face 16 of a heat conduction pipe 13. Also, it is preferable that as a refrigerant liquid flowed in the heat exchanging part 12, a thermal medium fluid having a high boiling point is used, not to be boiled due to a high temperature EGR gas.

Similarly, the post-EGR gas cooler 3 is coupled to a bonnet 21 in which an introduction hole 18 and an outlet hole 20 of the EGR gas are installed at both ends of the body pipe 17 having a cylinder shape, and an introduction hole 18 is coupled to a second supplying pipe 4, and an outlet hole 20 is coupled to an outlet pipe 5. And a plurality of the heat conduction pipe 23 are placed on the heat exchanging part 22 of the body pipe 17, and it makes possible to introduce a medium temperature EGR gas introduced from a second supplying pipe 4 through the introduction hole 18.

And, a refrigerant supply path 24 and a refrigerant discharging route 25 are coupled to a heat exchanging part 22 to flow a refrigerant liquid, and the heat exchange of a medium temperature EGR gas and a refrigerant liquid is performed through the heat conduction face 26 of the heat conduction pipe 23, made of metal or resin. Also, only the appropriately cooled medium temperature EGR gas is introduced into the post-EGR gas cooler 3, so that it is possible to perform cooling at a low price by using a low-priced thermal medium having a low boiling point such as a refrigerant water with no problem of boiling. And the EGR gas is efficiently indirect-cooled through the heat conduction face 26 made of resin by a thermal medium having a low boiling point. The low temperature EGR gas after cooling is discharged to a discharging pipe 5 from an outlet hole 20, and returning to an intake manifold through the discharging pipe 5.

In addition, the heat conduction pipe 23 of the post-EGR gas cooler 3 may be made of a heat resisting metal pipe, a stainless steel pipe and the like. However, the EGR gas of a medium temperature cooled by the pre-EGR gas cooler 1 is introduced into the post-EGR gas cooler 3, which results in no need of a high heat resistance such as metal materials. Accordingly, the heat conduction pipe 23 made of resin, for example, having some heat resistance as shown in Table 1 may be used, which can decrease its manufacturing cost comparing to metallic pipes. Many kinds of resins may be employed, if heat resistance is not much required.

TABLE 1

| | | | Temperature | | | |
|---|---|---|---|---|---|---|
| | | | when bending | | | |
| | | | is occurred. | | Continuous using | |
| | | | 0.45 | 1.82 | temperature | |
| | | | MPa | MPa | (electric) | Melting Point |
| Name of resin | Symbol | Grade | ° C. | ° C. | ° C. | ° C. |
| Monomer cast | PA | Heat | >215 | >200 | 150 | 200 |
| nylon | | resistance | | | | |
| Polyamideimide | PAI | N | — | 278 | 250 | — |
| | | Glass | — | 271 | 260 | — |
| | | filled | — | 278 | 250 | — |
| | | sliding | | | | |
| Polybenzo- | PBI | N | — | 435 | 345 | — |
| imidazol | | | | | | |
| Polyether | PEEK | N | — | 155 | 250 | 340 |
| ether ketone | | GF 30% | — | 230 | 250 | 334 |
| | | Sliding | — | 195 | 250 | 340 |
| | | Conduction | — | 230 | 250 | 340 |
| Polyetherimide | PEI | N | 210 | 200 | 170 | — |
| | | GF 30% | 212 | 210 | 170 | — |
| Polyether | PES | N | 210 | 203 | 180 | — |
| sulphone | | GF 30% | — | 216 | 180 | — |
| Polyimide | PI | N | — | 360 | 304 | — |
| Polypenylene | PPS | N | — | 121 | 220 | 282 |
| sulphonate | | GF 40% | — | 260 | 220 | 278 |
| sulfide | | | | | | |
| Polysulphonate | PSU | GF 30% | 190 | 185 | 160 | — |
| Polytetra- | PTFE | | 121 | 55 | 260 | 327 |
| fluoro | | | | | | |
| ethylene | | | | | | |
| Tetrafluoro | PFA | | 74 | 47 | 260 | 310 |
| ethylene | | | | | | |
| bafluoro | | | | | | |
| alckoksy | | | | | | |
| alkane | | | | | | |
| Fluoroethylene- | FEP | | 72 | 50 | 200 | 275 |
| propylene | | | | | | |
| Polychlorotri- | PCTFE | | 126 | — | 177 to 220 | 220 |
| fluoro ethylene | | | | | | |
| Tetrafluoroeth- | ETFE | | 104 | 74 | 150 to 180 | 270 |
| ylene ethylene | | | | | | |
| Ethylene | ECTFE | | 116 | 77 | 165 to 180 | 220 to 245 |
| chlorofluoro | | | | | | |
| ethylene | | | | | | |

Method for exchanging heat in the EGR gas cooler of embodiment 1 as previously described will be described. First of all, the EGR valve 6 located between the pre-EGR gas cooler 1 and the post-EGR gas cooler 3 is opened. The opening amount of valve is adequately adjusted to introduce a desired amount of the EGR gas to the EGR gas cooling apparatus in accordance with the flow rate or the temperature of the EGR gas, the driving condition of an engine. The EGR gas is then introduced into a supplying pipe 2 through a connecting route from the EGR pipe positioned at an exhaust manifold side by the opening amount of valve. And the EGR gas of a high temperature is introduced into a number of the heat conduction pipe 13 in the pre-EGR gas cooler 1 via the supply path 8 coupled to the supplying pipe 2. And the EGR gas of a high temperature, when flowing in the heat conduction pipe 13, is effectively heat exchanged with a refrigerant liquid flowing in the heat exchanging part 12 through a metallic heat conduction face 16 of the heat conduction pipe 13. This heat exchange causes the EGR gas of a high temperature to be indirectly cooled to a medium temperature which is lower than the introduction temperature but higher than the final target cooling temperature.

As described above, the high-temperature EGR gas is introduced to the pre-EGR gas cooler 1. Accordingly, the heat conduction face 16 made of a metal is maintained at a certain level of a high temperature. Furthermore, the temperature difference between the EGR gas and the thermal medium fluid having a high boiling point becomes small to make thermal stress small, and the precipitation of the water vapor in the EGR gas or the condensate of unburned gas, sulfuric acid solution, hydrocarbon and the like can be prevented. As a result, soot becomes difficult to be attached, but easy to be removed, thereby preventing the sooty from being deposited on the heat conduction face 16 and allowing heat exchange to be conducted effectively by maintaining high heat conduction property. And the EGR gas of a medium temperature cooled in the pre-EGR gas cooler 1 is discharged into the second supplying pipe 4 via the delivery route 10.

Although the medium temperature EGR gas passes through the EGR valve 6, as described above, the EGR gas is already cooled in the pre-EGR gas cooler 1, and does not induce the precipitation of highly corrosive condensate or the accumulation of viscous soot with high bulk density particles. Accordingly, the actuator of the EGR valve 6 may be prevented from being heated to a high temperature and from being corroded. Even though the soot is mixed with the EGR gas, it is hard to be attached in the EGR valve 6 due to the low bulk density of particles and its dryness, thereby preventing disadvantage such as adhesion from being occurred.

Next, the EGR gas of a medium temperature passed through the EGR valve 6 is then introduced to a post-EGR gas cooler 3 via the supply path 18 coupled to the second supplying pipe 4, and flows in a plurality of the heat conduction pipes 23 mounted on the heat exchanging part 22. During the flow process, the EGR gas of a medium temperature is heat exchanged with a thermal medium fluid having a low boiling point through the heat conduction face 26 made of a metal or a resin. The EGR gas of a low temperature cooled to a target cooling temperature is discharged from the delivery route 20 to a discharge pipe 5 and returned to the intake manifold.

The EGR valve 6 is located between the pre-EGR gas cooler 1 and the post-EGR gas cooler 3 as described above, therefore it can be protected from the precipitation of high-temperature of high corrosive condensate and the accumulation of high bulk density viscous soot. Furthermore, the actuator comprising an air cylinder, an electronic valve, a diaphragm and so on can be prevented from deteriorating, thus both of the durability of the EGR valve 6 and the reliability of the product are improved. In addition, it is not required to employ an expensive seal component or an anticorrosive metallic material having a high heat resistance and anti-corrosion, and to employ a cooling device, thus the EGR valve 6 with a simple and compact structure may be provided at a low price. Particularly, in the case of the two-port type EGR valve in which a pair valve discs built in the flow path of the EGR gas are opened and closed with a pair of valves built in the valve shaft, it is not necessary to perform a restrict adjustment of parts in consideration of the difference in the coefficient of thermal expansion due to the difference in materials. Therefore, manufacturing cost is reduced to provide the inexpensive EGR valve 6, which can maintain a high air-tightness or a smooth operating property for a long time.

In addition, in comparison with a conventional heat exchange rate in which the EGR gas introduced at a high temperature in one heat exchanging part is cooled to the target cooling temperature, heat is exchanged in the pre-EGR gas cooler 1 and in the post-EGR gas cooler 3 one after the other. Accordingly, it allows each heat exchanging part 12, 22 to exchange a relatively smaller heat rate and to make the size of the parts 12, 22 smaller. This results in smaller heat distortion in each pre-EGR gas cooler 1 and post-EGR gas cooler 3, thereby providing smaller heat stress leading to an improved durability not only in the EGR valve 6 but also in the EGR gas cooling apparatus. Further, the compact parts provide an increased mounting flexibility of the EGR gas cooling apparatus for an automobile.

In addition, since the metallic heat conduction face 16 does not corrode in the pre-EGR gas cooler 1, it is not necessary to employ an expensive anti-corrosive material in the heat conduction pipe, the heat conduction plate, a lead material of the pre-EGR gas cooler 1. In the post-EGR gas cooler 3, the difference between the EGR gas and the thermal medium fluid having a low boiling point becomes small so that heat stress can be small. Further, a corrosive condensed liquid is prevented from being generated or a sticky sooty is prevented from being deposited to thus avoid the deterioration of a heat conduction rate in the metallic heat conduction face 26. Also, in the case of the resin heat conduction face 26, it is possible to avoid the deterioration of resin material by introducing the EGR gas having a medium temperature. That is, although the temperature difference between the EGR gas and the thermal medium fluid having a low boiling point is getting bigger and a condensed liquid is generated, the anti-corrosive of the resin heat conduction face 26 to the condensate is excellent, and a soot, when it is attached, is easily to be removed from the resin heat conduction face 26. Accordingly, the durability of the pre-EGR gas cooler 1 and the post-EGR gas cooler is improved respectively, and thus excellent heat exchanging performance is maintained to make an effective heat exchange possible.

In the case of employing the heat conduction pipe 23 made of a resin in the post-EGR gas cooler 3, the heat conduction pipe 23 is formed with black resin material so that heat conduction rate of the heat conduction face 26 is getting higher and a cooling effect of the EGR gas can be improved. A highly heat-conductive metallic material such as copper, aluminum, stainless steel etc., a carbonic material or particles made of a glass and/or a fiber may be included in the resin material of the heat conduction pipe 23, or a paint mixed with a metallic powder may be applied to the face of the resin material, or the metallic powder may be applied or vacuum evaporated to the face of the resin material so that heat exchanging rate can be improved. Further, the metallic material, the carbonic material or the particle made of a glass or a fiber may be included in the black resin material. Thus, the heat exchanging performance can be effectively improved. Further, the excellent manufacturing characteristics of the resin material results in a free designing for the heat conduction face 26, which allows prominences and depressions, a winding face, a groove, a projection or a pin to be mounted on the heat conducting face 26. Accordingly, it is possible to provide an excellent heat conduction characteristic by enlarging the area of the heat conducting face.

In addition, a carbonic nano-fiber may also be included in the resin material, which allows the heat conduction property of the resin material to be improved further and thus the heat exchanging performance of the heat conducting pipe 23 to improve further. Also, in this case, a carbonic nano-fiber may be included in the resin material from 5 wt % to 30 wt % in order to get the best heat conducting rate. When the weight percentage of the carbonic nano-fiber is 5 wt % or less, the improvement of the heat conducting effect is not sufficient. Accordingly, it is not recommended to include more than 30 wt % of the carbonic nano-fiber in the resin material, because it does not show any difference in the heat conducting effect even though it deteriorates the productivity and it requires a large cost.

In addition, the carbonic nano-fiber described in this specification is referred to as a general term including carbonic nano-tube, carbonic nano-horn and other carbonic nano-fiber in the field of nano-technology. Also, a carbonic nano-tube, a carbonic nano-horn, and others may be mixed and included in the resin material, and may also be included in a unit. In addition, when the carbonic nano-tube is included in the resin material, it may include either a single layer or multiple layers. Furthermore, an aspect ratio of each layer does not matter, and the thickness, length of the carbonic tube does not matter as well.

[Second Embodiment]

In a second embodiment as shown in drawing 2, similar to the first embodiment, the pre-EGR gas cooler 1 is coupled to the post-EGR gas cooler 3 in series, the EGR valve 6 is mounted in the second supplying pipe 4 connecting the coolers 1, 3 so that the amount of the EGR gas being introduced to the EGR gas cooling apparatus can be adjusted. In addition, in the second embodiment, a temperature sensor 27 is mounted between the pre-EGR gas cooler 1 and the EGR valve 6. And the temperature sensor measures the temperature of the medium temperature EGR gas cooled in the pre-EGR cooler, and monitors the temperature to maintain at 150° C. to 200° C.

Also, because the EGR gas having high temperature of 150° C. or more is introduced to the pre-EGR gas cooler 1 a thermal medium fluid of a high boiling point such as fluorine inert solvent having the boiling point of 150° C. or more is employed, in order not to make the refrigerant liquid boiled in the heat exchanging part 12. In addition, a cooler 28 for supplying and reusing the thermal medium fluid having a high boiling point is coupled to the pre-EGR gas cooler 1. In the cooler 28 for refrigerant liquid the thermal medium fluid having a high boiling point is supplied to the heat exchanging part 12 of the pre-EGR gas cooler 1 via a refrigerant inlet 14 by a circulation pump 30 driven by an electronic motor. The thermal medium fluid having a high boiling point whose temperature increases from the cooling of the high-temperature EGR gas is then returned to the cooler 28 for refrigerant liquid via a refrigerant outlet 15, and cooled in the cooler 28 for refrigerant liquid to be supplied back to the pre-EGR gas cooler 1. This cooler 28 for refrigerant liquid may be in either air-cooling type using a radiator or liquid cooling type using a refrigerant liquid having a low boiling point such as a coolant.

The system monitors the temperature of the EGR gas of a medium temperature from the pre-EGR gas cooler 1 measured by the temperature sensor 27 to keep it at between 150° C. to 200° C. However, when the EGR gas having a medium temperature is cooled to a temperature of below 150° C., the temperature of the heat conduction face 16 in the pre-EGR gas cooler 1 is getting partially lower to provide a bigger thermal stress, or a condensate together with the soot are generated on the heat conduction face 16, which results in the deposition of a high bulk density viscous soot. Accordingly, the condensate or the viscous soot is introduced to the EGR valve 6 through the second supplying pipe 4, thereby causing the components to be corroded and clogged.

In order to avoid such a disadvantages, the cooling of the thermal medium fluid having a high boiling point in the cooler 28 for the refrigerant liquid is suppressed by operating the circulation pump 30 or a control valve 31 to control the flux, if it seems that the temperature of the EGR gas of a medium temperature is below 150° C. This allows the temperature of the heat conduction face to keep over 150° C. which is higher than the dew point of the EGR gas at all the time. Further, water vapor, non-combustion gas, sulfuric acid solution, hydrocarbon in the EGR gas is turned into a condensate to prevent themselves from being attached to the heat conduction face 16 and thus to prevent the viscous soot from being deposited. Accordingly, the condensate and the soot can be prevented from being introduced to the EGR valve 6.

On the other hand, in the case the temperature measured by the temperature sensor 27 becomes higher than 200° C. due to the lack of heat exchanging capacity at the pre-EGR gas cooler 1 caused by the large amount of introduced high temperature EGR gas, the temperature of the EGR valve increase, which may cause the air-tightness to deteriorate and the component to be degraded. With this reason, in this embodiment, when it seems that the temperature of the EGR gas having a medium temperature is over 200° C., the circulation pump 30 or a control valve 31 of the cooler for refrigerant liquid 28 are operated to increase a flow rate, which results in a promoted cooling and supplying of the thermal medium fluid having a high boiling point. Accordingly, the extremely heated EGR gas is not introduced to the EGR valve 6, and the disadvantage in the EGR valve 6 due to a high temperature can be solved.

And, the EGR gas having a medium temperature passed through the EGR valve 6 is introduced to the post-EGR gas cooler 3 and flows in the heat conduction pipe 23 located in the heat exchanging part 22. During the flow process, the EGR gas of a medium temperature is heat exchanged with a thermal medium fluid having a low boiling point through the heat conduction face 26. The EGR gas of a low temperature cooled to the target cooling temperature is returned to the intake manifold via the discharging pipe 5.

As described above, the temperature sensor 27 and the cooler 28 for refrigerant liquid are mounted so that the heat exchanging rate in the pre-EGR gas cooler 1 is adjusted in accordance with the temperature or the flow rate of the EGR gas introduced to the EGR gas cooling apparatus, and the EGR gas can be effectively cooled. It is possible to maintain a temperature in which a corrosive condensate or a high bulk density viscous soot is not generated, and to introduce the EGR gas at the temperature which does not cause the deterioration of sealing property or the degrade of parts. Accordingly, the long lasting, high durability product can be provided, maintaining excellent functions as a high durability valve.

Even though the present invention is embodied to the EGR gas cooling apparatus employing the heat conduction pipe 13, 23 in the first and the second embodiments, the one employing a heat conduction plate can be embodied as well. In the second embodiment, the temperature of the EGR gas having a medium temperature introduced to the EGR valve 6 and the post-EGR gas cooler 3 is adapted to keep at 150° C. to 200° C. However, the introduction temperature may be set other than 200° C. in accordance with a heat resisting temperature of the EGR valve 6 and the post-EGR gas cooler 3. And the upper limit temperature may be set higher than 200° C., when the heat resisting temperature is high. And, the lower limit temperature may be set lower than 200° C., when the heat resisting temperature is relatively low. Also, the lower limit temperature is preferably set at 150° C. in order to prevent a condensate from being generated and to prevent a viscous soot from being deposited. However, the lower limit temperature may be set below 150° C., when the generating of the condensate or the depositing of the sooty in an engine or fuel is small. In addition, the lower limit temperature may be set higher than 150° C., when either the EGR vale 6 or the post-EGR gas cooler 3 has a relatively high heat resistance.

The present invention as above described does not cool the EGR gas introduced at a high temperature from the exhaust manifold through the EGR pipe with the opening of the EGR valve to the target cooling temperature at once with a single heat-exchanging part, which has been done in the past. Instead, the present invention cools the gas to the temperature where the precipitation of condensate or the accumulation of high bulk-density viscous soot do not happen at the heat-exchanging part of the pre-EGR gas cooler, and introduces this medium-temperature EGR gas which is cooled to a given temperature to the heat-exchanging part of the post-EGR gas cooler and cools it to the target cooling temperature while controlling the flux with the EGR valve, and, finally, returns the low-temperature EGR gas to the intake manifold.

Therefore, to the EGR valve arranged between the pre-EGR gas cooler and the post-EGR cooler is introduced the medium-temperature EGR gas that is cooled to a given temperature at the pre-EGR gas cooler, but has no possibility of the precipitation of high-corrosive condensate and the accumulation of high bulk-density viscous soot. Thus, the depreciation of sealing property or the deterioration of parts due to thermal expansion or corrosion is difficult to happen. Therefore an EGR valve that can maintain a high air-tightness or a smooth operating characteristic for a long time and has an excellent durability can be obtained.

In addition, it is not necessary to use a expensive high thermal resistance and high corrosion resistance material for sealing and to do a restrict adjusting in consideration of the difference in the coefficient of thermal expansion rate due to the difference in material between the valve shaft built between the valves and the main body mounting the valve discs. In addition, it is not necessary to install cooling section for EGR valve such as air-cooling or liquid-cooling, and the size-reduction, weight-reduction and simplification of the EGR valve can be achieved, thus the EGR valve that is cheap in its price resulting from the decrease in manufacturing cost, and excellent in its storage efficiency can be obtained. Also the maintenance cost can be decreased.

In addition, as described above, the EGR gas is cooled step by step with two EGR gas coolers, therefore the amount of heat a single heat-exchanging part should exchange becomes smaller than that the conventional technology did. Thus the size of the EGR gas cooler can be decreased, and the heat-distortion becomes small, and the thermal stress can be decreased. In addition, the temperature difference between the EGR gas and the refrigerant at each heat-exchanging part becomes small, thus the thermal stress decreases and the durability of each EGR gas cooler can be improved. In addition, comparing with the case in which a single large-size EGR gas cooler is installed in an automobile, the degree of freedom in layout will increase by installing two small-sized EGR gas coolers connected with each other in it.

In addition, the temperature of the pre-EGR gas cooler can always be maintained above the dew point of the EGR gas, because no low-temperature EGR gas is introduced into it. Therefore the precipitation of the condensate of vapor, unburned gas, sulfuric acid solution, hydrocarbon etc in the EGR gas on the heat-conducting face can be prevented. Thus it is not necessary to use an expensive high corrosion-resistance material for the heat conducting pipe or the heat conducting plate, lead material etc., and thus the manufacturing cost can be decreased. In addition, the soot is rarely accumulated and the heat-conducting characteristic of the heat-conducting face is not damaged, thus the EGR gas and the refrigerant liquid can exchange heat effectively. In addition, to the post-EGR gas cooler is introduced only the medium-temperature EGR gas which has already been cooled to a given temperature at the pre-EGR gas cooler, it is not necessary to establish a severe heat-resistant countermeasure, and the post-EGR gas cooler can be formed at a low cost, and the temperature difference between the EGR gas and the refrigerant liquid is small, the heat-conducting pipe or the heat-conducting plate manufactured with a high heat-resistant resin material makes the adhesion of the soot on the heat-conducting face more difficult and its removal easier, and thus the accumulation of soot can be restrained, and finally, its durability and its heat-exchanging efficiency can be increased.

1. An EGR gas cooling apparatus comprising:
a pre-EGR gas cooler for cooling EGR gas introduced from EGR pipe;
an post-EGR gas cooler for introducing and cooling the EGR gas cooled in the pre-EGR gas cooler; and
an EGR valve for connecting in series the pre-EGR gas cooler and the post-EGR gas cooler, which controls the flow rate of the EGR gas which installed between the pre-EGR gas cooler and the post-EGR gas cooler.

2. The EGR gas cooling apparatus according to claim 1, wherein
the pre-EGR gas cooler indirectly cools the EGR gas by circulating a fluid having a high boiling point in a heat exchanger.

3. The EGR gas cooling apparatus according to claim 2, wherein
the pre-EGR gas cooler is coupled to a cooler for a refrigerant liquid which indirectly cools a thermal medium fluid having a high boiling point by air-cooling or liquid-cooling;
a circulating-pump and/or a controlling-valve are provided in the supply path of a heating medium fluid having a high boiling point from the cooler for the refrigerant liquid; and
the flow rate of the thermal medium fluid having a high boiling point of the heat exchanging part of the pre-EGR gas cooler is controlled or stopped of supplying by increasing and decreasing the flow rate of the circulation pump and/or by opening and closing the controlling-valve.

4. The EGR gas cooling apparatus according to claim 1, wherein
the pre-EGR gas cooler cools the EGR gas to a temperature of 150° C. to 200° C.

5. The EGR gas cooling apparatus according to claim 2, wherein a boiling point of the thermal medium fluid is 150° C. or more.

6. The EGR gas cooling apparatus according to claim 3, wherein
a boiling point of the thermal medium fluid is 150° C. or more.
